(19) United States
(12) Patent Application Publication
(10) Pub. No.: US 2010/0063890 A1
(43) Pub. Date: Mar. 11, 2010

(54) Methods and Systems for Generating, Qualifying, and Processing Leads

(75) Inventor: David Huckleby, Atlanta, GA (US)

Correspondence Address: PHILIP H. BURRUS, IV, 460 Grant Street, Atlanta, GA, 30312, US

(73) Assignee: COMPUCREDIT CORPORATION, Atlanta, GA (US)

(21) Appl. No.: 12/207,007

(22) Filed: Sep. 9, 2008

(51) Int. Cl. G06Q 30/00

(52) U.S. Cl. 705/26; 705/1

(57) ABSTRACT

Methods and systems for generating, qualifying, and processing business leads are provided. Additionally, methods and systems are provided for the management of leads based upon various selective criteria for prospective customers of short-term loans and other financial services products. Furthermore, an interactive system and method for centralized lead management and subsequent location-based distribution of leads, accompanied by real-time telephonic verification and call transfer, in an objective, timely, and cost-effective manner, is provided.

### FIELD OF THE INVENTION

The technology described herein relates generally to methods and systems for generating, qualifying, and processing business leads. More specifically, this technology relates to the management of leads based upon various selective criteria for prospective customers of short-term loans and other financial services products. Additionally, this technology relates to an interactive system and method for centralized lead management and subsequent location-based distribution of leads, accompanied by real-time telephonic verification and call transfer, in an objective, timely, and cost-effective manner.

### BACKGROUND OF THE INVENTION

In order to maintain a competitive advantage in the marketplace, it is vital for businesses to continually seek new business leads. Additionally, it is critical for such businesses to effectively and efficiently qualify each lead against various evaluation criteria before following up with the lead or routing the lead to another business entity. Furthermore, many businesses rely on a broad network of local stores, business partners, affiliates, or the like, to whom such leads are routed for personal customer contact in a local retail environment.

There are many types of business leads to be generated, qualified, and processed. By way of example, a growing customer market exists of persons seeking financial services products that falls outside of, or is underserved by, the traditional banking industry. These financial services products can include, for example, short-term loans, service payments to financial services companies, check-cashing, electronic tax filing, tax-filer loans, credit cards, installment loans, permanent general insurance, prepaid credit cards, title loans, electronic money transfers, and electronic bill-pay services.

The following patents are known in the art. U.S. Pat. No. 5,966,695, issued to Melchione et al. on Oct. 12, 1999, discloses a sales and marketing support system using a graphical query database. U.S. Pat. No. 7,305,364, issued to Nabe et al. on Dec. 4, 2007, discloses supplying customer leads to dealers. U.S. Pat. No. 5,930,764, issued to Melchione et al. on Jul. 27, 1999, discloses a sales and marketing support system using a customer information database. U.S. Pat. No. 7,035,699, issued to Anderson et al. on Apr. 25, 2006, discloses a qualified and targeted lead selection and delivery system. U.S. Pat. No. 7,216,102, issued to Nabe on May 8, 2007, discloses the auctioning of pre-selected customer lists.

The following published patent applications are known in the art. U.S. Patent Application Publication No. 2007/0118435, filed by Ran and published on May 24, 2007, discloses matching vendors with customers. U.S. Patent Application Publication No. 2006/0265259, filed by Diana et al. and published on Nov. 23, 2006, discloses the automated attachment of segmentation data to hot contact leads for facilitating matching of leads to interested lead buyers. U.S. Patent Application Publication No. 2004/0143476, filed by Kapadia et al. and published on Jul. 22, 2004, discloses providing sales lead information to agents. U.S. Patent Application Publication No. 2005/0044036, filed by Harrington et al. and published on Feb. 24, 2007, discloses distributing centrally received leads. U.S. Patent Application Publication No. 2007/0112582, filed by Fenlon and published on May 17, 2007, discloses value-added reselling of marketing leads from multiple lead sources. U.S. Patent Application Publication No. 2004/0143482, filed by Tivey et al. and published on Jul. 22, 2004, discloses the validation of sales leads. U.S. Patent Application Publication No. 2005/0131760, filed by Manning et al. and published on Jun. 16, 2005, discloses advanced prospecting features for generating targeted business-to-business sales leads and mailing lists. U.S. Patent Application Publication No. 2005/0137968, filed by Mitchell and published on Jun. 23, 2005, discloses internet based marketing and information management for mortgage loans. U.S. Patent Application Publication No. 2006/0195385, filed by Khetrapal et al. and published on Aug. 31, 2006, discloses exchanging sales leads. U.S. Patent Application Publication No. 2006/0106673, filed by Resare and published on May 18, 2006, discloses collecting, qualifying, and distributing customer leads resulting in increased rate of return on marketing investment. U.S. Patent Application Publication No. 2006/0242000, filed by Giguiere and published on Oct. 26, 2006, discloses capturing and consolidating leads.

The foregoing patent information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patents do not teach or render obvious, singly or when considered in combination, the inventor's claimed invention.

### BRIEF SUMMARY OF THE INVENTION

In various exemplary embodiments, the technology described herein provides systems and methods for generating, qualifying, and processing business leads. More specifically, this technology provides the management of leads based upon various selective criteria for prospective customers of short-term loans and other financial services products. Additionally, this technology provides an interactive system and method for centralized lead management and subsequent location-based distribution of leads, accompanied by real-time telephonic verification and call transfer, in an objective, timely, and cost-effective manner.

In one exemplary embodiment, the technology provides a method for generating, qualifying, and processing business leads. The method includes inputting incoming lead data derived from a plurality of lead sources, storing incoming lead data in a central database, communicating a message to a prospective customer derived from the incoming lead data that the prospective customer is prospectively eligible for a financial services product at a local retail location geographically proximate to the prospective customer, telephonically contacting the prospective customer, interviewing, by a customer service representative, the prospective customer to confirm interest and eligibility based on a plurality of predetermined criteria, conferencing the customer service representative, a representative from the local retail location, and the prospective customer, and processing an application for the financial services product at the local retail location with the prospective customer and scheduling an appointment for the prospective customer to visit the local retail location to complete the application for the financial services product.

The incoming lead data can be comprised of a prospective borrower lead previously declined for a loan product by a third party provider. The prospective borrower lead may have been previously declined for an online, internet loan product by a third party provider. The prospective borrower lead is rapidly and automatically input into the central database upon being declined by the third party provider.

The method also includes screening the incoming lead data to check if a lead is already a customer and screening the incoming lead data to check if the lead is a former customer with a negative history. The method also includes confirming that a lead from the incoming lead data has not already been entered into a call queue and inputting the confirmed lead into the call queue as a prospective customer.

The message that is electronically communicated to the prospective customer includes contact information for the retail location geographically proximate to the prospective customer. The message states that the prospective customer will shortly receive a call from the customer service representative, and wherein the message states that the prospective customer can call in to a customer service center.

The method also includes verifying that a telephone number for the prospective customer is not on a do-not-call list before contacting the prospective customer. The method further includes communicating a second message to the prospective customer when the prospective customer is unable to be reached telephonically. The second message includes contact information for the retail location geographically proximate to the prospective customer.

The method also includes scripting a call for the customer service representative telephonically contacting the prospective customer, wherein the scripting is state-specific, providing a first script for a live contact with the prospective customer, and providing a second script for a follow-up message when unable to make live contact with the prospective customer. The method further includes qualifying the prospective customer, when telephonically contacting the prospective customer and making a live contact, based on a plurality of state-specific criteria including verifying an active checking account, a current employment, and a state-issued identification.

The method includes telephonically contacting the representative from the local retail location to make a preliminary notification that an interested and eligible prospective customer is geographically proximate to the local retail location and is available for an introduction. The method also includes managing and routing prospective customers derived from incoming lead data based upon a plurality of predetermined criteria including geographic location and lead sources. The method further includes providing weather information and map directions to the customer service representative to make available to the prospective customer and providing cross-sell opportunities (e.g. additional products and services that might interest the customer) to the customer service representative to make available to the prospective customer.

In another exemplary embodiment, the technology provides a system for generating, qualifying, and processing business leads. The system includes a central database to store incoming lead data derived from a plurality of leads sources, a graphical user interface for use by a customer service representative communicating with prospective customers derived from the incoming lead data, and a computer readable storage medium encoded with programming. The programming is configured to: search the central database, communicate electronically a message to a prospective customer derived from the incoming lead data that the prospective customer is prospectively eligible for a product at a local retail location geographically proximate to the prospective customer, prompt the customer service representative to telephonically contact the prospective customer and interview the prospective customer to confirm interest and eligibility based on a plurality of predetermined criteria, and prompt the customer service representative to conference in telephonically a representative from the local retail location with the prospective customer and transfer the prospective customer to the representative from the local retail location for processing an application for the product and scheduling an appointment for the prospective customer to visit the local retail location to complete the application for the product.

The programming encoded in the computer readable storage medium also is configured to screen the incoming lead data to check if a lead is already a customer and if the lead is a former customer with a negative history, confirm that a lead from the incoming lead data has not already been entered into a call queue, and input the confirmed lead into the call queue as a prospective customer. The programming is also configured to verify that a telephone number for the prospective customer is not on a do-not-call list before the prospective customer is telephonically contacted, display a script for a call for the customer service representative to telephonically contact the prospective customer, wherein the script is state-specific, provide a first script for a live contact with the prospective customer, and provide a second script for a follow-up message when unable to make live contact with the prospective customer.

The programming is configured to prompt the customer service representative to telephonically contact the representative from the local retail location to make a preliminary notification that an interested and eligible prospective customer is geographically proximate to the local retail location and is available for an introduction. The programming is also configured to manage and route prospective customers derived from incoming lead data based upon a plurality of predetermined criteria including geographic location and lead sources. The programming is further configured to provide weather information and map directions to the customer service representative to make available to the prospective customer and provide cross-sell opportunities to the customer service representative to make available to the prospective customer.

There has thus been outlined, rather broadly, the features of this technology in order that the detailed description that follows may be better understood, and in order that the present contribution to the art may be better appreciated. There are additional features of the invention that will be described and which will form the subject matter of the claims. Additional aspects and advantages of this technology will be apparent from the following detailed description of an exemplary embodiment which is illustrated in the accompanying drawings. The technology described is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The technology described herein is illustrated with reference to the various drawings, in which like reference numbers denote like system components and/or method steps, respectively, and in which:

FIG. 1 is a schematic diagram illustrating a system architecture for generating, qualifying, and processing business leads, according to an embodiment of the technology described herein;

FIGS. 2, 3, 4, and 5 are flowchart diagrams illustrating method steps for generating, qualifying, and processing business leads, according to an embodiment of the technology described herein;

FIG. 6 is a diagram illustrating an incoming leads screen available to a customer service representative, according to an embodiment of the technology described herein;

FIG. 7 is a diagram illustrating a lead detail screen available to a customer service representative, according to an embodiment of the technology described herein; and

FIG. 8 is a block diagram illustrating the general components of a computer according to an exemplary embodiment of the technology.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides systems and methods for generating, qualifying, and processing business leads. More specifically, this technology provides the management of leads based upon various selective criteria for prospective customers of short-term loans and other products. Additionally, this technology provides an interactive system and method for centralized lead management and subsequent location-based distribution of leads, accompanied by real-time telephonic verification and call transfer, in an objective, timely, and cost-effective manner.

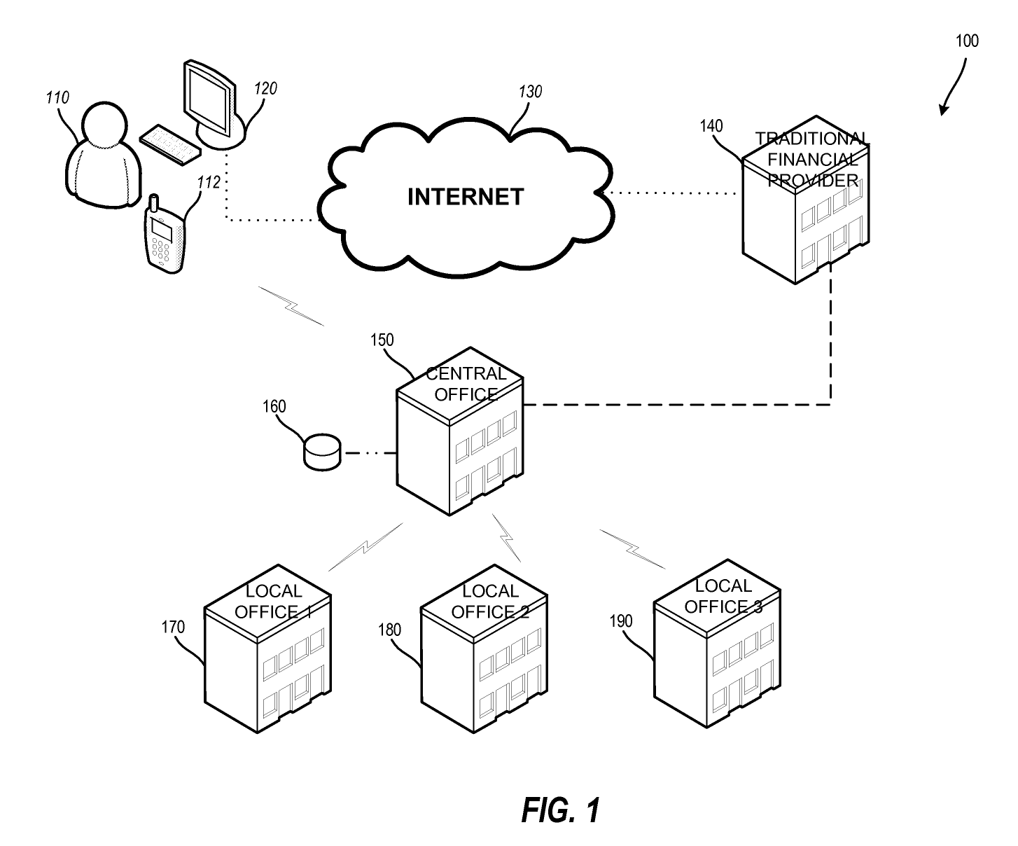

Referring now to FIG. 1, a system architecture 100 for generating, qualifying, and processing business leads is shown. There are many types of business leads to be generated, qualified, and processed. By way of example, a growing customer market exists of persons seeking products that falls outside of, or is underserved by, the traditional banking industry.

As shown in FIG. 1, a prospective customer 110 contacts a traditional financial services provider 140 to obtain a desired financial services product. The prospective customer 110 can utilize a phone 112 to contact the traditional financial services provider 140. Additionally, the prospective customer 110 can utilize a computer terminal 120 on a network, such as the internet 130, to contact the traditional financial services provider 140. The financial services products sought can include, for example, short-term loans, service payments to financial services companies, check-cashing, electronic tax filing, tax-filer loans, credit cards, installment loans, permanent general insurance, prepaid credit cards, title loans, electronic money transfers, and electronic bill-pay services.

As is known, if the traditional financial services provider 140 rejects an application by the prospective customer 110 for any of these products, based upon qualification criteria of that traditional financial services provider 140, the prospective customer 110 receives a rejection and is left with no immediate alternative for the desired financial product. This technology, however, provides an immediate opportunity for the prospective customer 110 to obtain the desired financial product by an alternative means.

A database 160 is maintained to include incoming leads from a multiplicity of sources. By way of example, any traditional financial provider 140, or the like, can transfer a lead (previously declined by that institution in many instances) to a central office 150 managing the database 160. Management of the database 160 includes, for example, searching and reviewing the incoming leads and evaluating the incoming leads against various filtering criteria. For incoming lead data that meets the filtering criteria, an electronic message is sent by email, text message or similar technological methods to the prospective customer 110 to note that he or she may be eligible for a financial services product at a geographically proximate local retail store.

A customer service representative at a central office 150, or the like, and with access to the database 160, contacts the prospective customer 110 to check interest in various financial services products and to qualify the prospective customer 110. The prospective customer 110 is interviewed based on various state-specific criteria. A prospective customer 110 meeting the various qualification requirements is connected by the customer service representative to a representative at a geographically proximate local retail store, one of 170, 180, 190, for example. After an introduction, the customer service representative at a central office 150 drops from the call and the prospective customer 110 continues an application process with the representative at the local retail store. The local representative continues the application process with the prospective customer 110 and sets up an appointment for visiting the local retail store 170, 180, 190 that is most geographically proximate or convenient to the prospective customer 110.

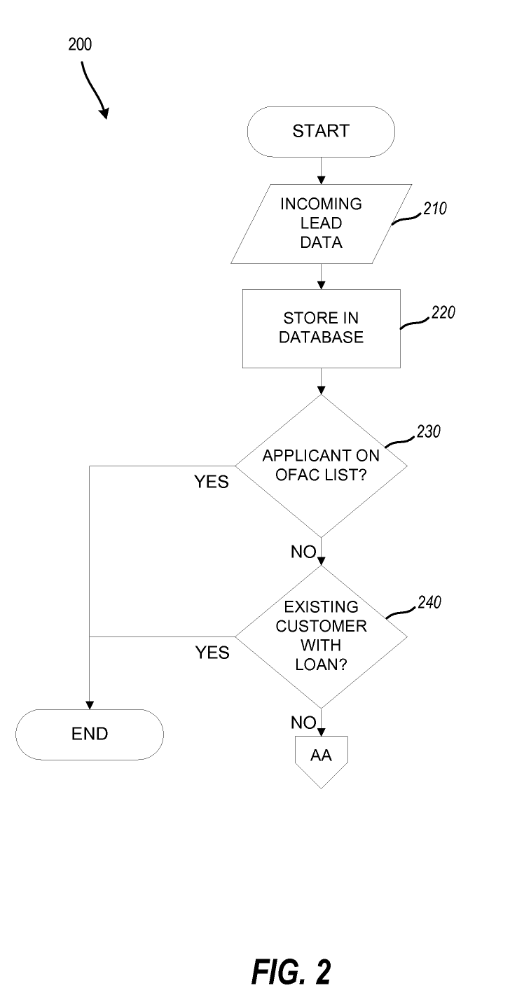

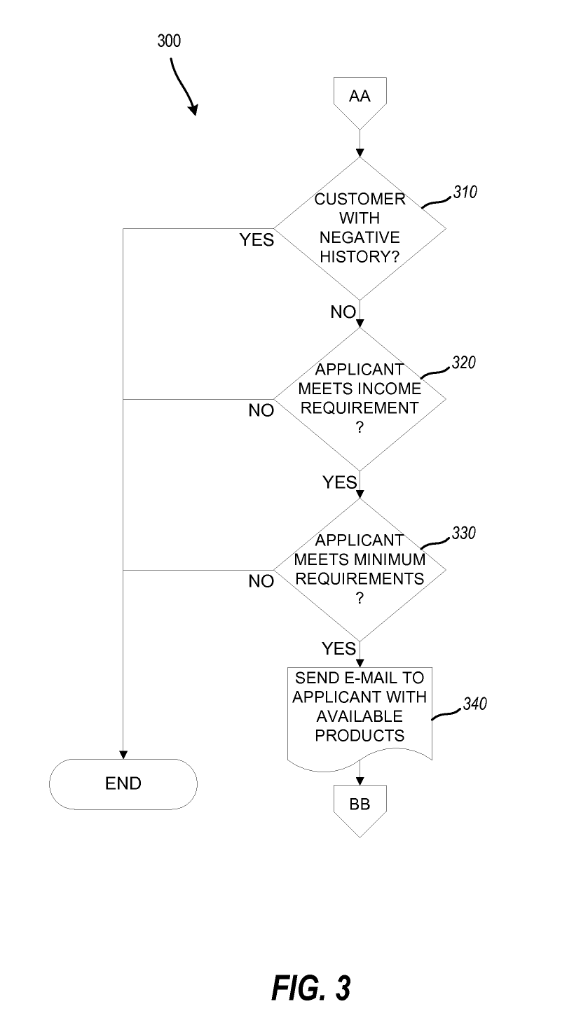

Referring now to FIGS. 2, 3, 4, and 5, flowchart diagrams 200, 300, 400, and 500 are provided illustrating method steps for generating, qualifying, and processing business leads operating, for example, in the system of FIG. 1.

As depicted in diagram 200, incoming lead data 210 is stored in a database 220. The incoming lead data 210 can originate from a multiplicity of sources. The data stored in database 220 is maintained securely and is accessible by customer services representatives, supervisors, management, etc., who can, for example, work from a central office. The data stored in database 220 is filtered based upon various criteria. The data filtering can be done programmatically and automatically or can be done by a customer service representative.

By way of example, the incoming lead data 210 will be filtered in step 230 to determine whether a prospective customer is on a list maintained by the Office of Foreign Assets Control (OFAC). The OFAC maintains a list of organizations and individuals sanctioned by the US government based upon foreign policy and national security goals. A name on the OFAC list is not eligible for a financial services product and the data record will be marked as such in the database. An additional filter to the incoming lead data 210 is to inquire whether a prospective customer is already an existing customer in step 240. If the lead is already a customer for a particular product, the lead is rejected. For example, if the customer already has an outstanding short-term loan, the customer can be deemed ineligible for another short-term loan. The customer, however, may be eligible for another financial services product. If the lead is not a customer, the process advances to the next step.

As depicted in diagram 300, incoming lead data 210 is subject to additional filtering. In step 310, each lead screened to determine whether the lead is a former customer having a negative history. If the lead is a former customer having a negative history, the lead is rejected. Additionally, the incoming lead data 210 is reviewed in step 320 to determine whether each lead meets certain income requirements that can be required for various financial services products. For example, an applicant for a short-term loan must provide proof of current employment income. As needed, other income criteria can be selected for use in this process. Furthermore, the incoming lead data 210 is reviewed in step 330 to determine whether each lead meets minimum application requirements. The minimum application requirements can vary based upon the financial services product desired, state in which the applicant resides, etc. The filtering criteria are dynamic and can be changed as needed. Leads meeting minimum income and application requirements are sent, in step 340, an electronic message stating that the prospective customer may be eligible for one or more financial services products. The prospective customer is informed that he or she will shortly receive a call. The prospective customer is also provided a number with which he or she can call in earlier if time is of the essence. Additionally, leads meeting minimum income and application requirements are placed in a call applicant queue to prompt a customer service representative.

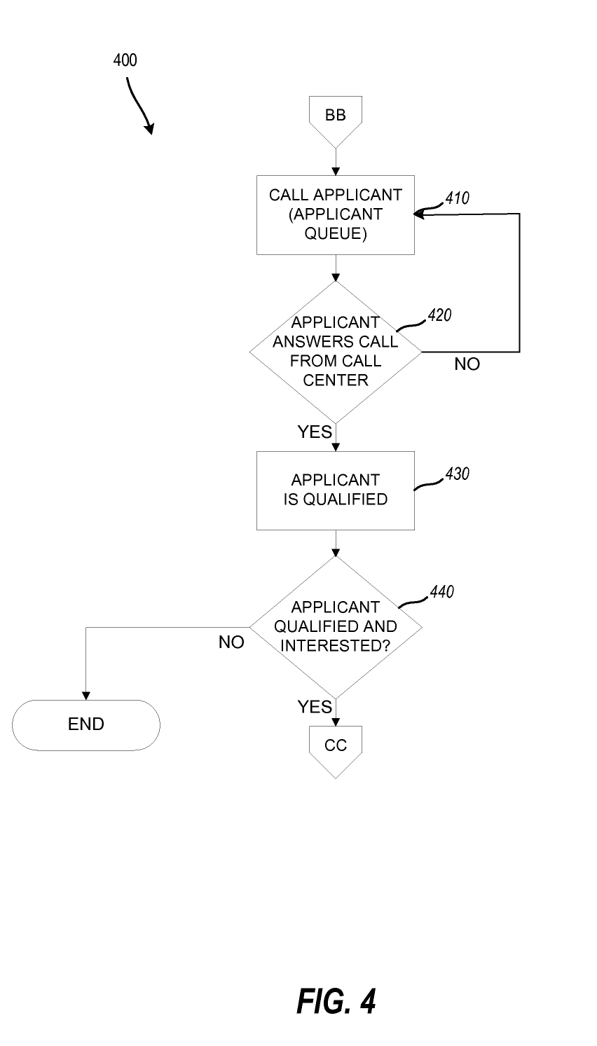

A customer service representative with access to the database 220 will obtain multiple incoming leads who are prospective customers from the call applicant queue available for additional qualifying and processing. Contact telephone numbers for each prospective customer are screened against do-not-call lists. Any number found on a do-not-call list is not called. By way of example, and as depicted in FIG. 4 diagram 400, a customer service representative calls a prospective customer in the order in which the lead was added the call queue 410. If an applicant does not answer in step 420 the call from the customer service representative, the lead is returned to the call applicant queue 410 for later processing. When the prospective customer is unable to be reached telephonically, a second message is electronically communicated to the prospective customer. The second message includes contact information for the retail location geographically proximate to the prospective customer. If an applicant answers the call in step 420, the applicant is qualified by the customer service representative in step 430.

The applicant qualification process can include various qualification criteria. By way of example, the applicant qualification 430 includes verifying the applicant has a valid and active checking account with an approved financial institution. Additionally, qualification can include verification of current employment and income and possession of a state-issued identification card. Additional qualification criteria can be added to this process as needed. The customer service representative verifies that a prospective customer is qualified and interested in obtaining a financial services product in step 440.

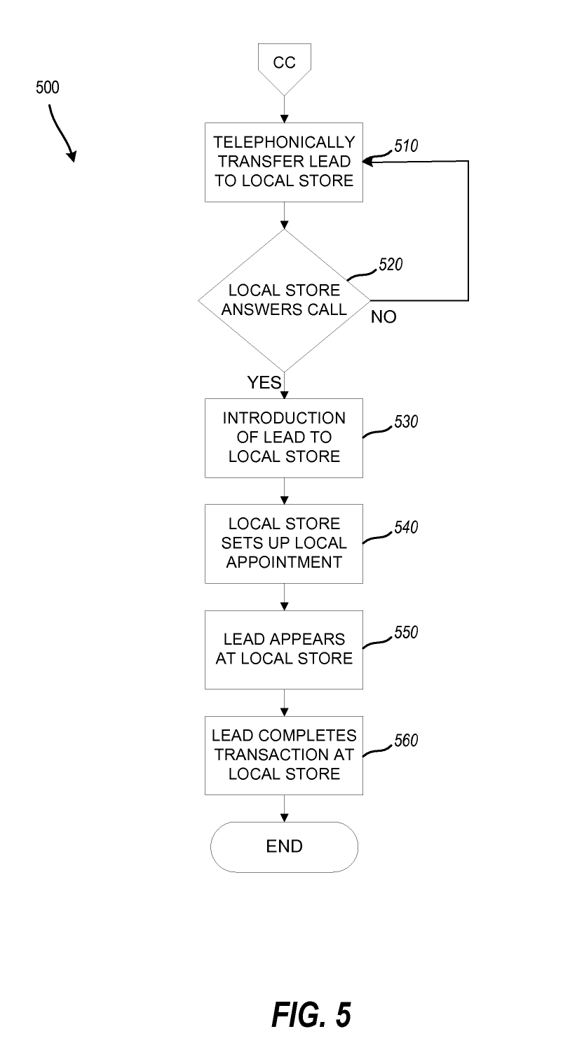

As depicted in FIG. 5 diagram 500, the process extends to now include a representative from a local retail store where the prospective customer may go to obtain the specific financial product desired in step 510. The customer service representative telephonically contacts a representative of a local retail store that is geographically proximate to the prospective customer in step 520. After introductions in step 530, the prospective customer lead is further qualified by the local representative and the customer service representative drops off of three-way call. If a representative at the local store does not answer the call, the customer service representative may try to introduce the prospective customer to the local representative at a later time, select another local store, or provide alternative follow-up instructions.

The representative of the local store sets up an appointment with the prospective customer in step 540. The prospective customer honors the appointment day and time and appears at the local store in step 550. The transaction for a financial services product is completed at the local store in step 560. By way of example, if the prospective customer was an applicant for a short-term loan, upon completion of the application process at the local store, the applicant leaves the store with a short-term loan.

In various embodiments, the process also includes providing a script to the customer service representative who is telephonically contacting the prospective customer. The script is state-specific to accommodate various state laws and practices. For example, a first script is used for a live contact with the prospective customer and a second script is used for a follow-up message when unable to make live contact with the prospective customer. Other scripts can be added to the system and call process. Additionally, the customer service representative is provided, on a lead detail screen, with weather information and map directions to make available to the prospective customer and encompasses the ability to forward such details to the prospective customer by various means including email, text message, and other electronic or wireless means. Furthermore, the customer service representative is provided, on a lead detail screen, with cross-sell opportunities to make available to the prospective customer.

In various embodiments, the process includes managing and routing prospective customers derived from incoming lead data based upon a plurality of predetermined criteria including geographic location and lead sources. For example, lead data can be managed based on a particular state or local retail store. Additionally, lead data can be limited based on lead source. A multiplicity of factors exists by which the lead data can be managed.

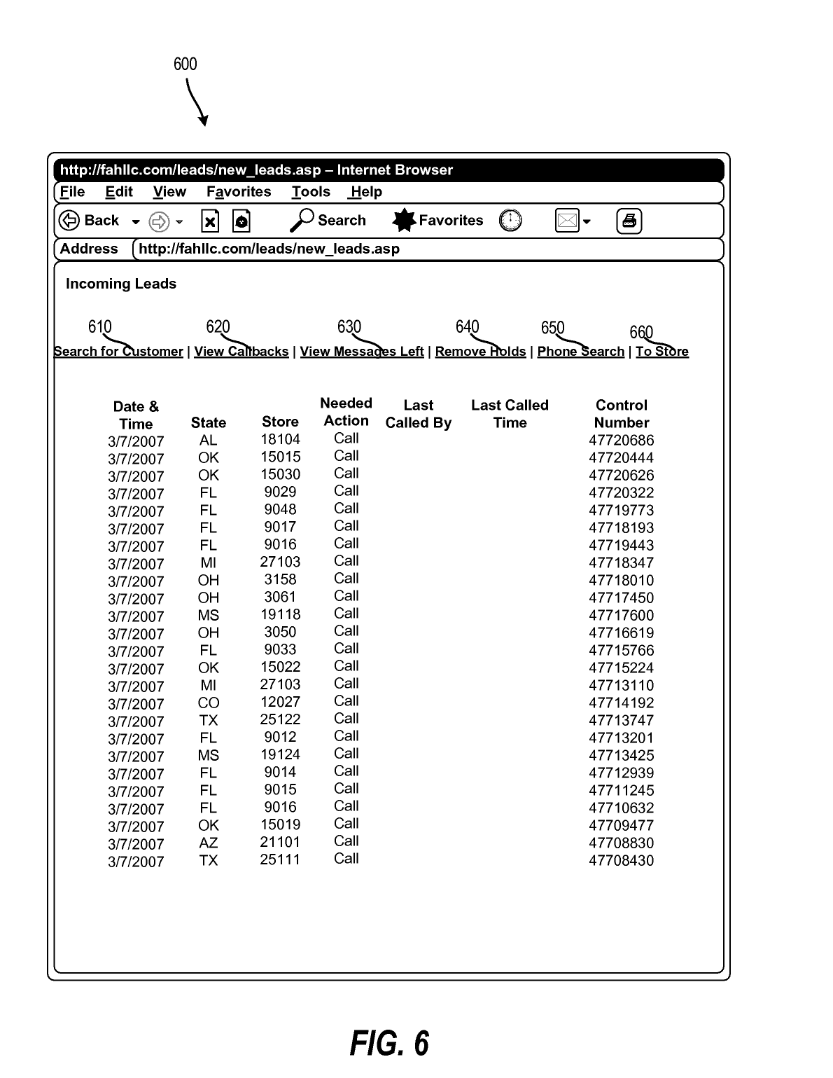

Referring now to FIG. 6, a diagram 600 illustrating an incoming leads screen available to a customer service representative is shown. The diagram 600 is exemplary. Other screen variations and views can be utilized to enable a customer service representative to properly contact leads. The customer service representative is provided with, for example, a list of incoming leads indicating the lead name, date and time, the store number of the store closest to the lead based on the geographical location of lead, a needed action status, and a control number. From the incoming leads screen, the customer service representative can search for a customer 610, view callbacks 620, view messages left 630, remove holds, 640, phone search 650, and make contact to a store 660. Additional fields such as weather conditions, distance from the customer's home to the store, distance from the customer's place of work to the store, and the like can be added. As a specific customer is selected, a lead detail screen is displayed.

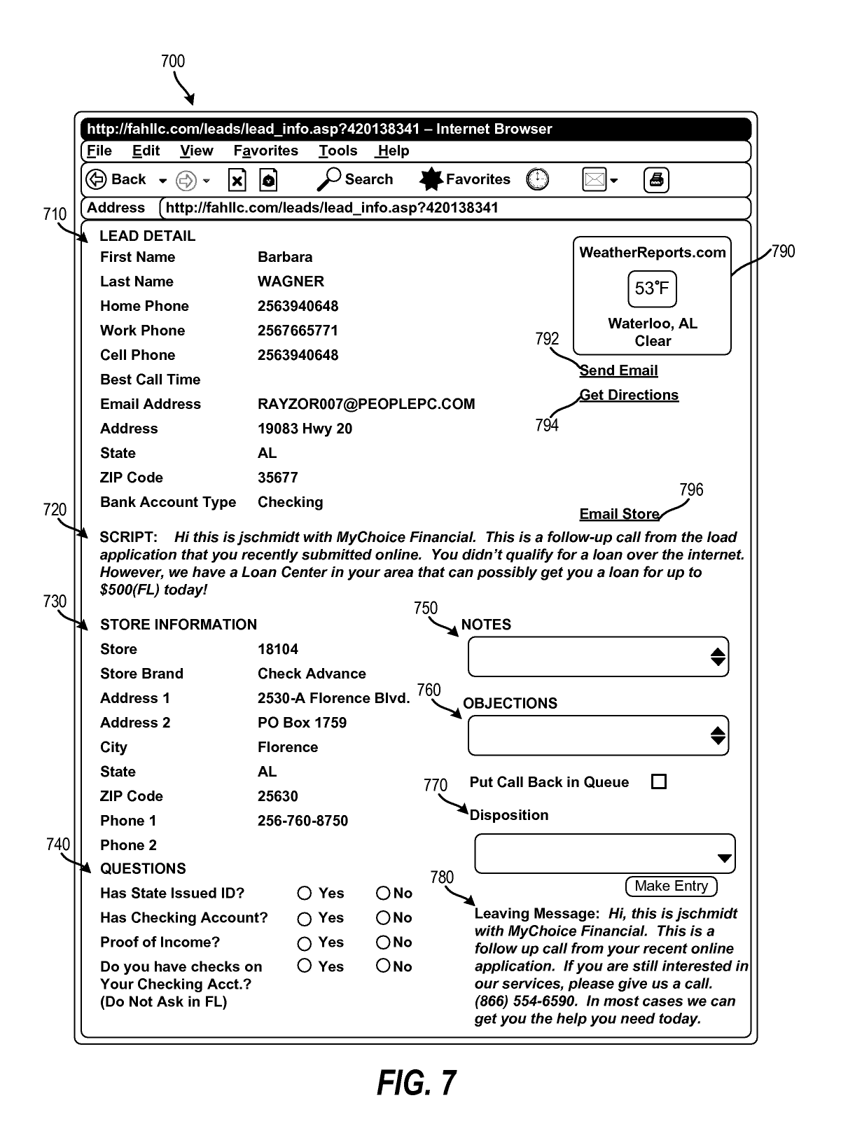

In that regard, reference is now made to FIG. 7, a diagram 700 illustrating a lead detail screen available to a customer service representative. Each lead detail 710 includes name, address, telephone, and e-mail information if available. The lead detail screen includes a script 720 to provide the customer service representative with introductory text. Name, address, telephone, and e-mail information is provided for the store 730 considered to be closest geographically to the lead address. For example, the store closest to the lead can be estimated based on the zip codes. The customer service representative is provided with questions to ask as part of the lead qualification process. Fields are provided to enable the customer service representative to enter notes 750 and objections 760. Once a call has been made, the customer service representative can log a disposition of the lead and call in step 770. If telephone contact is unable to be made with a live person, a scripted message in step 780 is provided to the customer service representative to leave in a voice mail message. Additional fields and hyperlink options can be added.

By way of example, weather 790 can be provided for geographical location in which the lead and local store are both located. Additionally, a map and directions 794 can be provided. E-mail messages can be sent to the lead 792 and to the local store 796 as needed. Links to cross-sell opportunities can also be provided on the lead detail screen.

The technology described herein can be realized in whole or in part on an information processing system, such as a networked personal computer and/or a networked server. The processes previously described and shown in the flowchart diagrams herein can be carried out by executing instructions contained in a computer-readable medium and read by the information processing system.

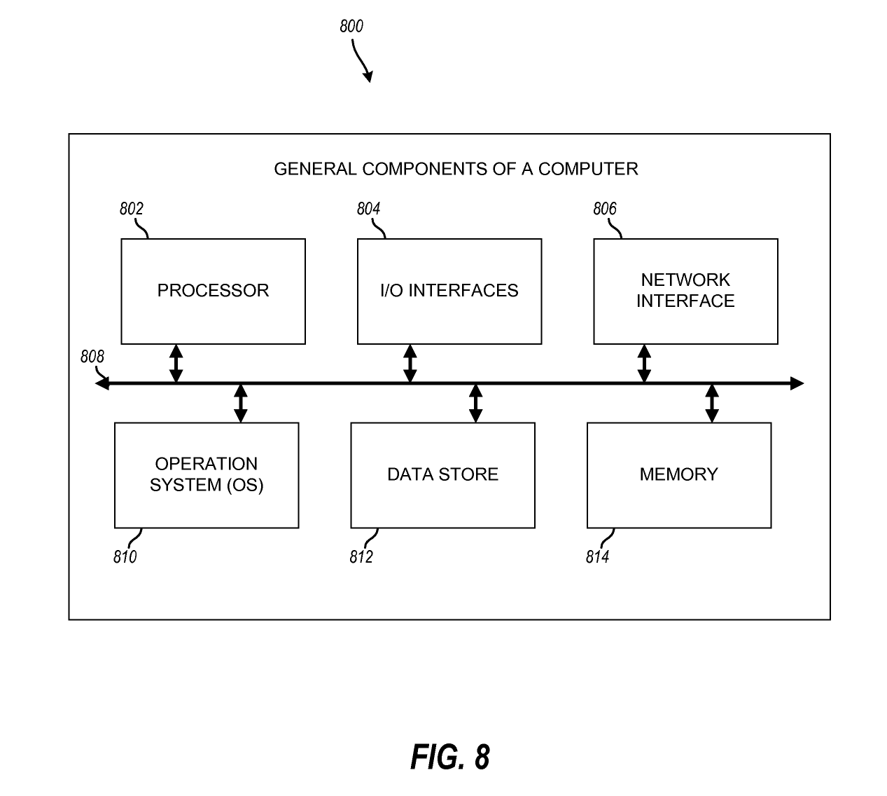

Referring now to FIG. 8, a block diagram 800 illustrating the general components of a computer is shown. The computer 800 can be a digital computer that, in terms of hardware architecture, generally includes a processor 802, input/output (I/O) interfaces 804, network interfaces 806, an operating system (O/S) 810, a data store 812, and a memory 814. The components (802, 804, 806, 810, 812, and 814) are communicatively coupled via a local interface 808. The local interface 808 can be, for example but not limited to, one or more buses or other wired or wireless connections, as is known in the art. The local interface 808 can have additional elements, which are omitted for simplicity, such as controllers, buffers (caches), drivers, among many others, to enable communications. Further, the local interface 808 can include address, control, and/or data connections to enable appropriate communications among the aforementioned components. The general operation of a computer comprising these elements is well known in the art.

The processor 802 is a hardware device for executing software instructions. The processor 802 can be any custom made or commercially available processor, a central processing unit (CPU), an auxiliary processor among several processors associated with the computer 800, a semiconductor-based microprocessor (in the form of a microchip or chip set), or generally any device for executing software instructions. When the computer 800 is in operation, the processor 802 is configured to execute software stored within the memory 814, to communicate data to and from the memory 814, and to generally control operations of the computer 800 pursuant to the software instructions.

The I/O interfaces 804 can be used to receive user input from and/or for providing system output to one or more devices or components. User input can be provided via, for example, a keyboard and/or a mouse. System output can be provided via a display device and a printer (not shown). I/O interfaces 804 can include, for example but not limited to, a serial port, a parallel port, a small computer system interface (SCSI), an infrared (IR) interface, a radio frequency (RF) interface, and/or a universal serial bus (USB) interface.

The network interfaces 806 can be used to enable the computer 400 to communicate on a network. For example, the computer 800 can utilize the network interfaces 808 to communicate via the internet to other computers or servers for software updates, technical support, etc. The network interfaces 808 can include, for example, an Ethernet card (e.g., 10BaseT, Fast Ethernet, Gigabit Ethernet) or a wireless local area network (WLAN) card (e.g., 802.11a/b/g). The network interfaces 808 can include address, control, and/or data connections to enable appropriate communications on the network.

A data store 812 can be used to store data, such as information regarding positions entered in a requisition. The data store 812 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 812 can incorporate electronic, magnetic, optical, and/or other types of storage media. In one example, the data store 812 can be located internal to the computer 800 such as, for example, an internal hard drive connected to the local interface 808 in the computer 800. Additionally in another embodiment, the data store can be located external to the computer 800 such as, for example, an external hard drive connected to the I/O interfaces 804 (e.g., SCSI or USB connection). Finally in a third embodiment, the data store may be connected to the computer 800 through a network, such as, for example, a network attached file server.

The memory 814 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 814 may incorporate electronic, magnetic, optical, and/or other types of storage media. Note that the memory 814 can have a distributed architecture, where various components are situated remotely from one another, but can be accessed by the processor 802.

The software in memory 814 can include one or more software programs, each of which includes an ordered listing of executable instructions for implementing logical functions. In the example of FIG. 8, the software in the memory system 814 includes the interactive process for generating, qualifying, and processing business leads and a suitable operating system (O/S) 810. The operating system 810 essentially controls the execution of other computer programs, such as the process for generating, qualifying, and processing business leads, input-output control, file and data management, memory management, and communication control and related services. The operating system 410 can be any of Windows NT, Windows 2000, Windows XP, Windows Vista (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), or other like operating system with similar functionality.

In an exemplary embodiment of the technology described herein, the computer 800 is configured to perform flowcharts 200, 300, 400, and 500 depicted in FIGS. 2, 3, 4, and 5 respectively. The process for generating, qualifying, and processing business leads utilizing computer 800 is configured specifically to perform these tasks. However, it should be noted that a computer 800 is not necessary for realizing the technology described herein.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A method for generating, qualifying, and processing business leads, the method comprising:
inputting incoming lead data derived from a plurality of lead sources;
storing incoming lead data in a central database;
communicating a message to a prospective customer derived from the incoming lead data that the prospective customer is prospectively eligible for a financial services product at a local retail location geographically proximate to the prospective customer;
contacting the prospective customer;
interviewing, by a customer service representative, the prospective customer to confirm interest and eligibility based on a plurality of predetermined criteria;
conferencing telephonically the customer service representative, a representative from the local retail location, and the prospective customer; and
processing an application for the financial services product at the local retail location with the prospective customer and scheduling an appointment for the prospective customer to visit the local retail location to complete the application for the financial services product.

2. The method for generating, qualifying, and processing business leads of claim 1, wherein the incoming lead data is comprised of a prospective borrower lead previously declined for a loan product by a third party provider.

3. The method for generating, qualifying, and processing business leads of claim 1, wherein the prospective borrower lead has been previously declined for an online, internet loan product by a third party provider and wherein the prospective borrower lead is rapidly and automatically input into the central database upon being declined by the third party provider.

4. The method for generating, qualifying, and processing business leads of claim 1, further comprising:
screening the incoming lead data to check if a lead is already a customer; and
screening the incoming lead data to check if the lead is a former customer with a negative history.

5. The method for generating, qualifying, and processing business leads of claim 1, further comprising:
confirming that a lead from the incoming lead data has not already been entered into a call queue; and
inputting the confirmed lead into the call queue as a prospective customer.

6. The method for generating, qualifying, and processing business leads of claim 1, wherein the message that is communicated to the prospective customer includes contact information for the retail location geographically proximate to the prospective customer, wherein the message states that the prospective customer will shortly receive a call from the customer service representative, and wherein the message states that the prospective customer can call in to a customer service center.

7. The method for generating, qualifying, and processing business leads of claim 1, further comprising:
verifying that a telephone number for the prospective customer is not on a do-not-call list before telephonically contacting the prospective customer.

8. The method for generating, qualifying, and processing business leads of claim 1, further comprising:
electronically communicating a second message to the prospective customer when the prospective customer is unable to be reached telephonically, and wherein the second message includes contact information for the retail location geographically proximate to the prospective customer.

9. The method for generating, qualifying, and processing business leads of claim 1, further comprising:
scripting a call for the customer service representative telephonically contacting the prospective customer, wherein the scripting is state-specific;
providing a first script for a live contact with the prospective customer; and
providing a second script for a follow-up message when unable to make live contact with the prospective customer.

10. The method for generating, qualifying, and processing business leads of claim 1, further comprising:
qualifying the prospective customer, when telephonically contacting the prospective customer and making a live contact, based on a plurality of state-specific criteria including verifying an active checking account, a current employment, and a state-issued identification.

11. The method for generating, qualifying, and processing business leads of claim 1, further comprising:
telephonically contacting the representative from the local retail location to make a preliminary notification that an interested and eligible prospective customer is geographically proximate to the local retail location and is available for an introduction.

12. The method for generating, qualifying, and processing business leads of claim 11, further comprising:
providing weather information and map directions to the customer service representative to make available to the prospective customer.

13. The method for generating, qualifying, and processing business leads of claim 11, further comprising:
providing cross-sell opportunities to the customer service representative to make available to the prospective customer.

14. The method for generating, qualifying, and processing business leads of claim 1, further comprising:
managing and routing prospective customers derived from incoming lead data based upon a plurality of predetermined criteria including geographic location and lead sources.

15. A system for generating, qualifying, and processing business leads, the system comprising:
a central database to store incoming lead data derived from a plurality of leads sources;
a graphical user interface for use by a customer service representative communicating with prospective customers derived from the incoming lead data; and
a computer readable storage medium encoded with programming configured to:
search the central database;
communicate electronically a message to a prospective customer derived from the incoming lead data that the prospective customer is prospectively eligible for a product at a local retail location geographically proximate to the prospective customer;
prompt the customer service representative to telephonically contact the prospective customer and interview the prospective customer to confirm interest and eligibility based on a plurality of predetermined criteria; and
prompt the customer service representative to conference in telephonically a representative from the local retail location with the prospective customer and transfer the prospective customer to the representative from the local retail location for processing an application for the product and scheduling an appointment for the prospective customer to visit the local retail location to complete the application for the product.

16. The system for generating, qualifying, and processing business leads of claim 15 wherein the programming is further configured to:
screen the incoming lead data to check if a lead is already a customer and if the lead is a former customer with a negative history;
confirm that a lead from the incoming lead data has not already been entered into a call queue; and
input the confirmed lead into the call queue as a prospective customer.

17. The system for generating, qualifying, and processing business leads of claim 15 wherein the programming is further configured to:
verify that a telephone number for the prospective customer is not on a do-not-call list before the prospective customer is telephonically contacted;
display a script for a call for the customer service representative to telephonically contact the prospective customer, wherein the script is state-specific;
provide a first script for a live contact with the prospective customer; and
provide a second script for a follow-up message when unable to make live contact with the prospective customer.

18. The system for generating, qualifying, and processing business leads of claim 15 wherein the programming is further configured to:
prompt the customer service representative to telephonically contact the representative from the local retail location to make a preliminary notification that an interested and eligible prospective customer is geographically proximate to the local retail location and is available for an introduction.

19. The system for generating, qualifying, and processing business leads of claim 15 wherein the programming is further configured to:
manage and route prospective customers derived from incoming lead data based upon a plurality of predetermined criteria including geographic location and lead sources.

20. The system for generating, qualifying, and processing business leads of claim 15 wherein the programming is further configured to:
provide weather information and map directions to the customer service representative to make available to the prospective customer; and
provide cross-sell opportunities to the customer service representative to make available to the prospective customer.
